(19) United States
(12) Patent Application Publication
(10) Pub. No.: US 2024/0174245 A1
(43) Pub. Date: May 30, 2024

(54) VEHICLE DRIVING ASSISTANCE APPARATUS, VEHICLE DRIVING ASSISTANCE METHOD, AND COMPUTER-READABLE STORAGE MEDIUM STORING VEHICLE DRIVING ASSISTANCE PROGRAM

(71) Applicant: TOYOTA JIDOSHA KABUSHIKI KAISHA, Toyota-shi (JP)

(72) Inventor: Tomoyuki DOI, Toyota-shi (JP)

(73) Assignee: TOYOTA JIDOSHA KABUSHIKI KAISHA, Toyota-shi (JP)

(21) Appl. No.: 18/508,640

(22) Filed: Nov. 14, 2023

(30) Foreign Application Priority Data
Nov. 30, 2022 (JP) 2022-191531

(51) Int. Cl. B60W 50/08; B60W 30/14; B60W 50/14

(52) U.S. Cl. CPC B60W 50/087; B60W 30/146; B60W 50/14; B60W 2050/146; B60W 2540/10; B60W 2720/10

(57) ABSTRACT

A vehicle driving assistance apparatus executes a first control to display a first image by a displaying device and a second control including an autonomous deceleration control to autonomously decelerate the vehicle in response to the traffic information. The first image is an image which displays traffic information on a place where a vehicle will move. The vehicle driving assistance apparatus renders the second control valid or invalid, starts to display the first image at a predetermined valid-state point of time in a situation where the second control is rendered valid, and starts to display the first image at a predetermined invalid-state point of time in a situation where the second control is rendered invalid. The predetermined invalid-state point of time is earlier than the predetermined valid-state point of time.

### CROSS-REFERENCE TO RELATED APPLICATIONS

This application claims priority to Japanese patent application No. JP 2022-191531 filed on Nov. 30, 2022, the content of which is hereby incorporated by reference in its entirety.

### BACKGROUND

### Field

The present invention relates to a vehicle driving assistance apparatus, a vehicle driving assistance method, and a computer-readable storage medium storing a vehicle driving assistance program.

### Description of the Related Art

There is known a vehicle driving assistance apparatus which displays a traffic sign on a display when the vehicle driving assistance apparatus detects the traffic sign. There is also known another vehicle driving assistance apparatus which displays the traffic sign on the display. This apparatus is configured to (i) display information relating to a deceleration of a vehicle when the vehicle is not decelerated after detecting traffic information showing a deceleration-required place, i.e., a place where the vehicle is required to be decelerated, and (ii) executes an autonomous deceleration control of autonomously decelerating the vehicle when the vehicle is not decelerated after displaying the information relating to the deceleration of the vehicle (for example, refer to JP 2021-133777 A).

When the traffic information such as the information relating to the deceleration of the vehicle, is not displayed in a situation where the autonomous deceleration control described above is rendered invalid, an operator of the vehicle may carry out an operation in response to the traffic information late. Moreover, in the situation where the autonomous deceleration control is rendered invalid, the autonomous deceleration control is not executed. Thus, the traffic information should be informed the operator of the vehicle early.

### SUMMARY

An object of the present invention is to provide a vehicle driving assistance apparatus which can early inform the operator of the vehicle of the traffic information on a place where the vehicle will move even in the situation where the autonomous deceleration control is rendered invalid.

According to the present invention, a vehicle driving assistance apparatus, comprises an electronic control unit. The electronic control unit is configured to execute a first control to display a first image by a displaying device and a second control including an autonomous deceleration control to autonomously decelerate the vehicle in response to the traffic information. The first image is an image which displays traffic information on a place where a vehicle will move. The electronic control unit is configured to render the second control valid or invalid, start to display the first image at a predetermined valid-state point of time in a situation where the second control is rendered valid, and start to display the first image at a predetermined invalid-state point of time in a situation where the second control is rendered invalid. The predetermined invalid-state point of time is earlier than the predetermined valid-state point of time.

In a situation where the autonomous deceleration control is rendered invalid, it is preferred that the first image is displayed at an earlier point of time, and the traffic information on the place where the vehicle will move, is informed the operator of the vehicle at the earlier point of time.

With the vehicle driving assistance apparatus according to the present invention, the first image is displayed at the earlier point of time in the situation where the second control including the autonomous deceleration control is rendered invalid, compared with in the situation where the second control is rendered valid. Thus, the traffic information on the place where the vehicle will move, can be informed the operator of the vehicle at the early point of time even in the situation where the second control is rendered invalid, that is, the autonomous deceleration control is rendered invalid.

According to an aspect of the present invention, the vehicle driving assistance apparatus may comprise a detection section which detects the traffic information on the place where the vehicle will move. In this aspect, the electronic control unit may be configured to execute one of the first control and the second control, based on a first area distance between the vehicle and a first area shown by the traffic information after the electronic control unit detects the traffic information. Further, in this aspect, the electronic control unit may be configured to start to display the first image at a point of time when the first area distance reaches a predetermined valid-state distance and start to display the first image at a point of time when the first area distance reaches a predetermined invalid-state distance. Furthermore, in this aspect, the predetermined invalid-state distance may be longer than the predetermined valid-state distance.

With the vehicle driving assistance apparatus according to this aspect of the present invention, the first image starts being displayed while the distance between the vehicle and the first area shown by the traffic information, is still long in the situation where the second control is rendered invalid, compared with in the situation where the second control is rendered valid. Thus, the traffic information on the place where the vehicle will move, can be informed the operator of the vehicle at the early point of time even in the situation where the second control is rendered invalid.

According to another aspect of the present invention, the electronic control unit may be configured to acquire a predicted reaching period of time as a parameter which represents the first area distance, start to display the first image at a point of time when the predicted reaching period of time reaches a predetermined valid-state period of time in the situation where the second control is rendered valid, and start to display the first image at a point of time when the predicted reaching period of time reaches a predetermined invalid-state period of time in the situation where the second control is rendered invalid. In this aspect, the predicted reaching period of time may be a period of time predicted for the vehicle to take to reach the first area. Further, in this aspect, the predetermined invalid-state period of time may be longer than the predetermined valid-state period of time.

With the vehicle driving assistance apparatus according to this aspect of the present invention, the first image starts to be displayed at a point of time when the predicted reaching time is long in the situation where the second control is rendered invalid, compared with in the situation where the second control is rendered valid. Thus, the traffic information on the place where the vehicle will move, can be informed the operator of the vehicle at the early point of time even in the situation where the second control is rendered invalid.

According to further another aspect of the present invention, the electronic control unit may be configured to execute the second control to execute the autonomous deceleration control after the electronic control unit starts to display one of the first image and a second image relating to the second control.

With the vehicle driving assistance apparatus according to this aspect of the present invention, the autonomous deceleration control starts to be executed after the first image or the second image starts being displayed. Thus, the autonomous deceleration control starts to be executed after the traffic information is informed the operator of the vehicle.

According to further another aspect of the present invention, the electronic control unit may be configured to display the first image after the electronic control unit starts displaying the second image in the situation where the second control is rendered valid.

With the vehicle driving assistance apparatus according to this aspect of the present invention, the first image is displayed after the second image starts being displayed in the situation where when the second control is rendered valid. Thus, the operator of the vehicle can be informed in a comprehensible manner of the traffic information when the operator is strongly required to carry out an operation in response to the traffic information.

According to further another aspect of the present invention, the electronic control unit may be configured to start to display the first image when an operator of the vehicle does not release an acceleration operation after the electronic control unit starts displaying the second image in the situation where the second control is rendered valid, and start to execute the autonomous deceleration control when the operator of the vehicle releases the acceleration operation after the electronic control unit starts displaying the first image in the situation where the second control rendered valid.

With the vehicle driving assistance apparatus according to this aspect of the present invention, the operator of the vehicle can be strongly alerted when the vehicle is strongly required to be decelerated, but the acceleration operation is not released and the autonomous deceleration control cannot be executed.

According to further another aspect of the present invention, the electronic control unit may be configured to display an image of recommending that the operator releases the acceleration operation as the second image.

With the vehicle driving assistance apparatus according to this aspect of the present invention, the image of recommending that the operator of the vehicle releases the acceleration operation, is displayed as the second image. Thus, the operator can be prompted to release the acceleration operation.

According to further another aspect of the present invention, the electronic control unit may be configured to execute the second control to (i) display a third image relating the second control, (ii) execute the autonomous deceleration control, and (iii) not display the first image when the operator of the vehicle has released the acceleration operation.

With the vehicle driving assistance apparatus according to this aspect of the present invention, the third image relating to the second control including the autonomous deceleration control starts to be displayed, and the autonomous deceleration control starts to be executed when the operator of the vehicle is released the acceleration operation. Thus, the operator of the vehicle can easily realize that the autonomous deceleration control is being executed.

According to further another aspect of the present invention, the electronic control unit may be configured to start to display the first image at a predetermined small-index-value point of time when the electronic control unit detects the traffic information, and a realization index value is smaller than a predetermined index value in a situation where the second control is requested to be executed, and start to display the first image at a predetermined great-index-value point of time when the electronic control unit detects the traffic information, and the realization index value is equal to or greater than the predetermined index value in a situation where the second control is requested to be executed. In this aspect, the realization index value may be an index value which represents a probability that the operator of the vehicle has realized a place where the vehicle is required to be decelerated. Further, in this aspect, the predetermined great-index-value point of time may be later than the predetermined small-index-value point of time.

When the operator of the vehicle has realized a deceleration-required place where the vehicle is required to be decelerated, it may be sufficient to display the image showing the traffic information providing the deceleration-required place at a point of time when the vehicle has approached the deceleration-required place. Thus, if the image starts to be displayed when the vehicle has not approached the deceleration-required place, the operator of the vehicle may feel bothersome.

With the vehicle driving assistance apparatus according to this aspect of the present invention, the first image starts to be delayed when a probability that the operator of the driver has realized the deceleration-required place, is high. Thus, the vehicle driving assistance apparatus can avoid a situation that the operator of the vehicle feels bothersome with the displayed image.

According to further another aspect of the present invention, when the electronic control unit detects the traffic information including first traffic information and second traffic information different from the first traffic information and displays the second image which shows the second traffic information, the electronic control unit may be configured to display the first image showing the first traffic information.

When the plural kinds of the traffic information are detected, it may be preferred that the traffic information is displayed as much as possible.

With the vehicle driving assistance apparatus according to this aspect of the present invention, when the first traffic information and the second traffic information are detected, the image showing the second traffic information is displayed as the second image, and the image showing the first traffic information is displayed as the first image. Thus, the vehicle driving assistance apparatus can display the traffic information as much as possible.

Further, a vehicle driving assistance method according to the present invention is a method for executing a first control to display a first image by a displaying device and a second control including an autonomous deceleration control to autonomously decelerate the vehicle in response to the traffic information. The first image is an image which displays traffic information on a place where a vehicle will move. The vehicle driving assistance method comprises steps of starting to display the first image at a predetermined valid-state point of time in a situation where the second control is rendered valid, and starting to display the first image at a predetermined invalid-state point of time earlier than the predetermined valid-state point of time in a situation where the second control is rendered invalid.

With the vehicle driving assistance method according to the present invention, for the reasons described above, the traffic information on the place where the vehicle will move, can be informed the operator of the vehicle at the early point of time even in the situation where the second control is rendered invalid, that is, the autonomous deceleration control is rendered invalid.

Furthermore, a computer-readable storage medium according to the present invention stores a vehicle driving assistance program. The vehicle driving assistance program executes a first control to display a first image by a displaying device and a second control including an autonomous deceleration control to autonomously decelerate the vehicle in response to the traffic information. The first image is an image which displays traffic information on a place where a vehicle will move. The vehicle driving assistance program is configured to start to display the first image at a predetermined valid-state point of time earlier than the predetermined valid-state point of time in a situation where the second control is rendered valid.

With the vehicle driving assistance program according to the present invention, for the reasons described above, the traffic information on the place where the vehicle will move, can be informed the operator of the vehicle at the early point of time even in the situation where the second control is rendered invalid, that is, the autonomous deceleration control is rendered invalid.

Elements of the present invention are not limited to elements of embodiments and modified examples of the present invention described with reference to the drawings. The other objects, features and accompanied advantages of the present invention can be easily understood from the embodiments and the modified examples of the present invention.

### BRIEF DESCRIPTION OF THE DRAWINGS

FIG. 1 is a view which shows a vehicle driving assistance apparatus according to an embodiment of the present invention.

FIG. 2 is a view which shows a meter display.

FIG. 3A is a view which shows the meter display displaying a continuously-lighting sign image.

FIG. 3B is a view which shows the meter display displaying a blinking sign image.

FIG. 4A is a view which shows the meter display displaying an accelerator pedal release recommendation image.

FIG. 4B is a view which shows the meter display displaying an autonomously-decelerating image.

FIG. 5 is a view which shows a target distance.

FIG. 6A is a view which shows the meter display displaying the accelerator pedal release recommendation image.

FIG. 6B is a view which shows the meter display displaying the accelerator pedal release recommendation image and the blinking sign image.

FIG. 6C is a view which shows the meter display displaying the autonomously-decelerating image.

FIG. 7 is a view which shows a flowchart of a routine executed by the vehicle driving assistance apparatus according to the embodiment of the present invention.

FIG. 8 is a view which shows a flowchart of a routine executed by the vehicle driving assistance apparatus according to the embodiment of the present invention.

FIG. 9 is a view which shows a flowchart of a routine executed by the vehicle driving assistance apparatus according to the embodiment of the present invention.

FIG. 10 is a view which shows a flowchart of a routine executed by the vehicle driving assistance apparatus according to the embodiment of the present invention.

### DESCRIPTION OF THE EMBODIMENTS

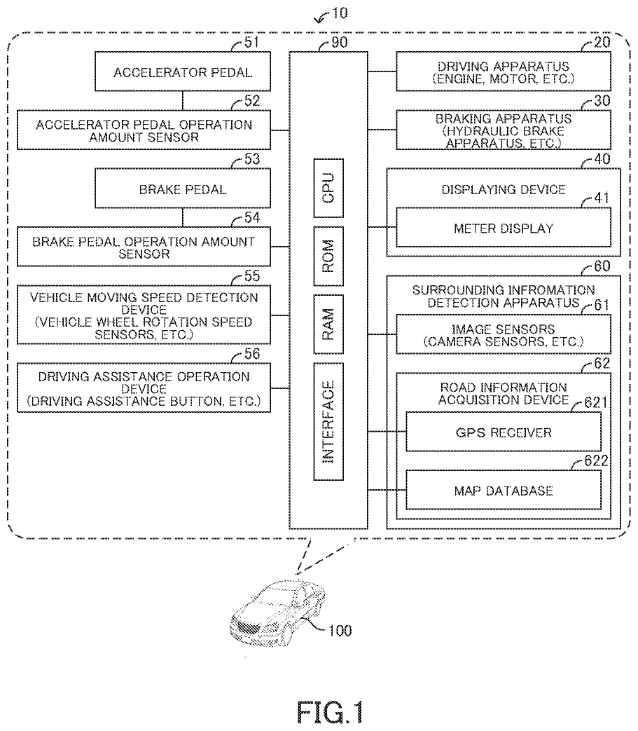

Below, a vehicle driving assistance apparatus according to an embodiment of the present invention will be described with reference to the drawings. Below, the vehicle driving assistance apparatus 10 according to the embodiment of the present invention will be described with an example that an operator of an own vehicle 100 is a driver of the own vehicle 100, i.e., a person who is in the own vehicle 100 and directly drives the own vehicle 100. Therefore, in the present embodiment, the vehicle driving assistance apparatus 10 is installed on the own vehicle 100 as shown in FIG. 1.

In this regard, the operator of the own vehicle 100 may be a remote operator of the own vehicle 100, i.e., a person who is outside of the own vehicle 100 and remotely drives the own vehicle 100. When the operator of the own vehicle 100 is the remote operator, the vehicle driving assistance apparatus 10 is installed on the own vehicle 100 and a remote operation facility provided outside of the own vehicle 100 for remotely driving the own vehicle 100. In this case, the vehicle driving assistance apparatus 10 installed on the own vehicle 100 shares functions of the vehicle driving assistance apparatus 10 described below with the vehicle driving assistance apparatus 10 installed on the remote operation facility.

The vehicle driving assistance apparatus 10 includes an ECU 90 as a control unit. The vehicle driving assistance apparatus 10 executes a braking assistance control and a vehicle-stopped-state holding control described later, respectively as autonomous driving controls for the own vehicle 100.

### ECU

The ECU 90 is an electronic control unit. The ECU 90 includes a micro-computer as a main component. The micro-computer includes a CPU, a ROM, a RAM, a non-volatile memory, and an interface. The CPU is configured or programmed to realize various functions by executing instructions, programs, or routines stored in the ROM. In the present embodiment, the vehicle driving assistance apparatus 10 includes one ECU. In this regard, the vehicle driving assistance apparatus 10 may include ECUs and be configured to execute various processes described later by the ECUs, respectively.

### Driving Apparatus, Etc

As shown in FIG. 1, a driving apparatus 20, a braking apparatus 30, and a displaying device 40 are installed on the own vehicle 100.

### Driving Apparatus

The driving apparatus 20 is an apparatus which outputs a driving force to be applied to the own vehicle 100. The driving apparatus 20 includes, for example, an internal combustion engine and/or at least one electric motor. The driving apparatus 20 is electrically connected to the ECU 90. The ECU 90 controls the driving force output from the driving apparatus 20.

### Braking Apparatus

The braking apparatus 30 is an apparatus which applies a braking force to the own vehicle 100. The braking apparatus 30 is, for example, a hydraulic brake apparatus. The braking apparatus 30 is electrically connected to the ECU 90. The ECU 90 controls the braking force applied to the own vehicle 100 by the braking apparatus 30.

### Displaying Device

The displaying device 40 is a device which displays various images. In the present embodiment, the displaying device 40 includes a meter display 41. The meter display 41 is provided in front of a driver's seat of the own vehicle 100. The meter display 41 is a device which provides the driver of the own vehicle 100 with various information by displaying the images.

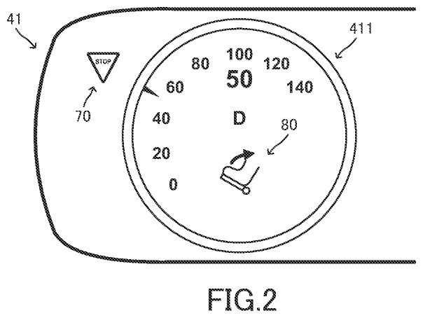

As shown in FIG. 2, in the present embodiment, the meter display 41 is configured to display a speed meter 411 in the form of the image. In addition, the meter display 41 is configured to display a sign image 70 (or a first image) at a predetermined area (or a sign image displaying area) and display a deceleration assistance image 80 (or a second image) at another predetermined area (or a deceleration assistance image displaying area).

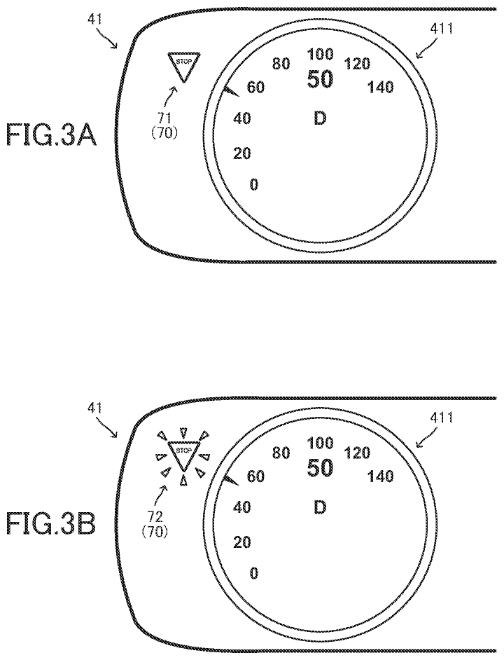

The sign image 70 is an image which shows traffic information. In the present embodiment, the sign image 70 is an icon image which shows a traffic sign indicating the traffic information. In the present embodiment, the sign image 70 includes a continuously-lighting sign image 71, i.e., the sign image which lights continuously as shown in FIG. 3A, and a blinking sign image 72, i.e., the sign image which blinks as shown in FIG. 3B.

It should be noted that the continuously-lighting sign image 71 is an information-providing image which provides the driver with the traffic information, and the blinking sign image 72 is an alerting image which alerts the driver to the traffic information.

Further, in the present embodiment, the traffic sign displayed as the sign image 70 is the traffic image which shows the traffic information for a place where the own vehicle 100 will move. In particular, the traffic sign displayed as the sign image 70 is a deceleration assistance target sign 300, i.e., the traffic sign provided on a road to inform that there is a deceleration assistance target thing 200 ahead of a vehicle. The deceleration assistance target thing 200 is a thing which requires a deceleration of the vehicle. The deceleration assistance target thing 200 includes a first area shown by the traffic information, i.e., a place where the vehicle is required to be decelerated. The traffic sign displayed as the sign image 70 includes, for example, a stop sign, an intersection sign, a stop line sign, a curve sign, and a railroad crossing sign. The stop sign is a regulatory sign which informs that there is a place where the vehicle is required to be stopped (i.e., the first area shown by the traffic information) ahead. The intersection sign is a warning sign which informs that there is a traffic intersection (i.e., the first area shown by the traffic information) ahead. The stop line sign is a direction sign which informs a position of a stop line (i.e., the first area shown by the traffic information). The curve sign is a warning sign which informs that there is a curved road (the first area shown by the traffic information) ahead. The railroad crossing sign is a warning sign which informs that there is a railroad crossing (the first area shown by the traffic information) ahead.

It should be noted that the deceleration assistance target thing 200 includes, for example, the stop line, the traffic intersection, the curved road, and the railroad crossing.

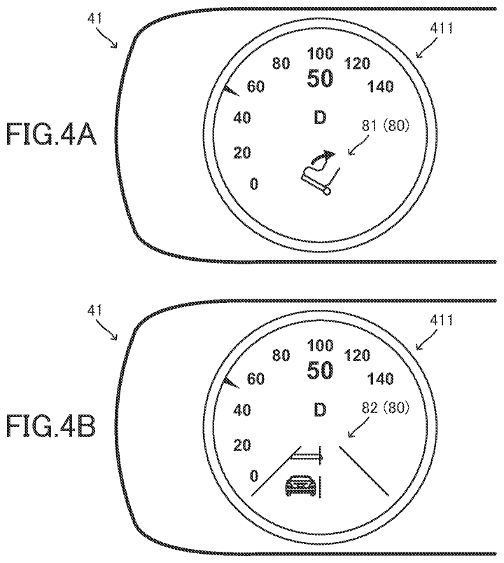

Further, the deceleration assistance image 80 is an image which shows the traffic information. In the present embodiment, the deceleration assistance image 80 is an icon image which shows information on the deceleration assistance target thing 200. In the present embodiment, the deceleration assistance image 80 includes an accelerator pedal release recommendation image 81 (i.e., the second image) shown in FIG. 4A and an autonomously-decelerating image 82 (i.e., the second image or a third image) shown in FIG. 4B.

The accelerator pedal release recommendation image 81 (i.e., the second image) is an image which recommends releasing an acceleration operation to the driver. In particular, the accelerator pedal release recommendation image 81 (i.e., the second image) is an image which recommends releasing an operation applied to an accelerator pedal 51 to the driver. The autonomously-decelerating image 82 (i.e., the second image or the third image) is an image which informs the driver that the own vehicle 100 is being decelerated by an autonomous deceleration control described later.

Further, in the present embodiment, the sign image displaying area which displays the sign image 70, is an area outside and left above the speed meter 411, and the deceleration assistance image displaying area which displays the deceleration assistance image 80, is a lower center area of the speed meter 411.

It should be noted that the displaying device 40 may be a head-up display. The head-up display is a device which provide the driver of the own vehicle 100 with various information by projecting various images on a front windshield of the own vehicle 100.

### Sensors, Etc

Further, the own vehicle 100 is installed with an accelerator pedal 51, an accelerator pedal operation amount sensor 52, a brake pedal 53, a brake pedal operation amount sensor 54, a vehicle moving speed detection device 55, a driving assistance operation device 56, and a surrounding information detection apparatus 60.

### Accelerator Pedal, Etc

The accelerator pedal 51 is a device which is operated by the driver to accelerate the own vehicle 100. The accelerator pedal operation amount sensor 52 is a device which detects an operation amount of the accelerator pedal 51. It should be noted that when the operator of the own vehicle 100 is the remote operator of the own vehicle 100, the accelerator pedal 51 and the accelerator pedal operation amount sensor 52 are installed on the remote operation facility.

The accelerator pedal operation amount sensor 52 is electrically connected to the ECU 90. The ECU 90 acquires the operation amount of the accelerator pedal 51 as an accelerator pedal operation amount AP by the accelerator pedal operation amount sensor 52. The ECU 90 calculates and acquires an acceleration rate of the own vehicle 100 requested by the driver as a driver-requested acceleration rate Ga_driver, based on the accelerator pedal operation amount AP. Except for a case that the ECU 90 executes a braking assistance control (or an autonomous deceleration control) described later, the ECU 90 executes a normal moving control of controlling the driving force output from the driving apparatus 20 so as to realize the driver-requested acceleration rate Ga_driver when the driver-requested acceleration rate Ga_driver is greater than zero.

### Brake Pedal, Etc

The brake pedal 53 is a device which is operated by the driver to decelerate the own vehicle 100. The brake pedal operation amount sensor 54 is a device which detects an operation amount of the brake pedal 53. It should be noted that when the operator of the own vehicle 100 is the remote operator of the own vehicle 100, the brake pedal 53 and the brake pedal operation amount sensor 54 are installed on the remote operation facility.

The brake pedal operation amount sensor 54 is electrically connected to the ECU 90. The ECU 90 acquires the operation amount of the brake pedal 53 as a brake pedal operation amount BP by the brake pedal operation amount sensor 54. The ECU 90 calculates and acquires a deceleration rate of the own vehicle 100 requested by the driver as a driver-requested deceleration rate Gd_driver, based on the brake pedal operation amount BP. Except for a case that the ECU 90 executes the braking assistance control (or the autonomous deceleration control) described later, the ECU 90 executes the normal moving control of controlling the braking force applied to the own vehicle 100 from the braking apparatus 30 so as to realize the driver-requested deceleration rate Gd_driver when the driver-requested deceleration rate Gd_driver is greater than zero.

### Vehicle Moving Speed Detection Device

The vehicle moving speed detection device 55 is a device which detects a moving speed of the own vehicle 100. For example, the vehicle moving speed detection device 55 includes vehicle wheel rotation speed sensors which are provided on each wheel of the own vehicle 100. The vehicle moving speed detection device 55 is electrically connected to the ECU 90. The ECU 90 acquires the moving speed of the own vehicle 100 as an own vehicle moving speed V by the vehicle moving speed detection device 55.

### Driving Assistance Operation Device

Further, the driving assistance operation device 56 is a device which is operated by the driver of the own vehicle 100. For example, the driving assistance operation device 56 is a driving assistance operation button. The driving assistance operation device 56 is electrically connected to the ECU 90. When (i) the ECU 90 determines that the deceleration assistance control (or the autonomous deceleration control) described later is not requested to be executed, and (ii) the driving assistance operation device 56 is operated, the ECU 90 determines that the deceleration assistance control is requested to be executed and renders the deceleration assistance control valid. To render the deceleration assistance control valid is to set the ECU 90 at a valid state, i.e., a state that the ECU 90 starts to execute the deceleration assistance control when a predetermined condition becomes satisfied. On the other hand, when (i) the ECU 90 determines that the deceleration assistance control (or the autonomous deceleration control) described later has been requested to be executed, and (ii) the driving assistance operation device 56 is operated, the ECU 90 determines that the deceleration assistance control is not requested to be executed and renders the deceleration assistance control invalid. To render the deceleration assistance control invalid is to set the ECU 90 at an invalid state, i.e., a state that the ECU 90 does not start to execute the deceleration assistance control even when the predetermined condition becomes satisfied.

### Surrounding Information Detection Apparatus

The surrounding information detection apparatus 60 is an apparatus which detects information on a situation around the own vehicle 100. In the present embodiment, the surrounding information detection apparatus 60 includes image sensors 61 and a road information acquisition device 62.

### Image Sensors

The image sensors 61 are sensors which take images of views around the own vehicle 100 and acquire image data on the taken images. The image sensors 61 are, for example, camera sensors. The image sensors 61 are electrically connected to the ECU 90. The ECU 90 acquires the image data as surrounding detection information IS from the image sensors 61.

For example, the ECU 90 detects the traffic signs, in particular, the deceleration assistance target sign 300, based on the image data. It should be noted that the traffic signs detected, based on the image data are the traffic signs which are provided ahead of the own vehicle 100.

### Road Information Acquisition Device

The road information acquisition device 62 is a device which acquires information on a road on which the own vehicle 100 is moving. In particular, in the present embodiment, the road information acquisition device 62 is a device which receives GPS signals and acquires a present position of the own vehicle 100 and map information on an area around the own vehicle 100. The map information on the area around the own vehicle 100 includes road information, i.e., information on the road on which the own vehicle 100 is moving.

In the present embodiment, the road information acquisition device 62 includes a GPS receiver 621 and a map database 622.

The GPS receiver 621 is a device which receives the GPS signals. The GPS receiver 621 is electrically connected to the ECU 90. The ECU 90 acquires the present position of the own vehicle 100, based on the GPS signals received by the GPS receiver 621.

The map database 622 is a device which stores map information. The map database 622 is electrically connected to the ECU 90. The ECU 90 acquires the map information on the area around the own vehicle 100 as the surrounding detection information IS from the map database 622, based on the present position of the own vehicle 100.

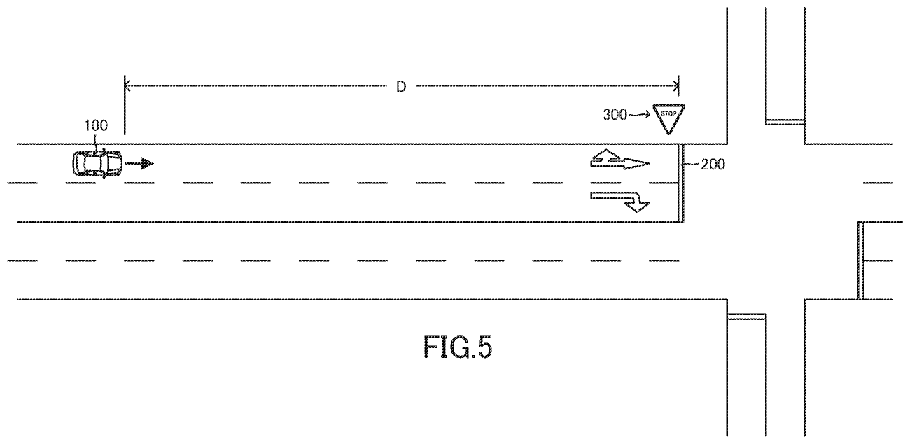

For example, the ECU 90 can detect the deceleration assistance target thing 200, based on the map information. In addition, the ECU 90 acquires a target distance D, based on the map information when the ECU 90 detects the deceleration assistance target thing 200. As shown in FIG. 5, the target distance D is a distance between the own vehicle 100 and the deceleration assistance target thing 200. It should be noted that the deceleration assistance target thing 200 shown in FIG. 5 is the stop line.

It should be noted that the surrounding information detection apparatus 60 may include a roadside signal-receiving device, i.e., a device which receives information on roads transmitted wirelessly from roadside equipment provided on a roadside. When the surrounding information detection apparatus 60 includes the roadside signal receiving device, the surrounding information detection apparatus 60 may be configured to acquire road information transmitted from the roadside equipment via the roadside signal receiving device as the surrounding detection information IS. In this case, the ECU 90 acquires a position of the deceleration assistance target thing 200 and the target distance D, based on the acquired road information.

Thus, the surrounding information detection apparatus 60 corresponds to a detection section which detects the traffic information on the place where the own vehicle 100 will move.

### Operations of Vehicle Driving Assistance Apparatus

Next, operations of the vehicle driving assistance apparatus 10 will be described.

The vehicle driving assistance apparatus 10 is configured to execute (i) a first control or a sign assistance control and (ii) a second control or a deceleration assistance control. The first control is a control of displaying the first image or the sign image 70 by the displaying device 40. The second control includes the autonomous deceleration control of autonomously decelerating the own vehicle 100 in response to the traffic information. In particular, in the present embodiment, the second control includes a displaying control of displaying the second image or the deceleration assistance image 80 different from the first image by the displaying device 40 in addition to the autonomous deceleration control.

In particular, in the present embodiment, the first control or the sign assistance control is a control of displaying the sign image 70 by the meter display 41 and then blinking the sign image 70 when a predetermined condition becomes satisfied.

In other words, the first control is a control of displaying the continuously-lighting sign image 71 as the first image or an information providing image by the meter display 41 and then displaying the blinking sign image 72 as the first image or an alerting image by the meter display 41 when the predetermined condition becomes satisfied.

On the other hand, in the present embodiment, the displaying control of the second control or the deceleration assistance control is a control of displaying the accelerator pedal release recommendation image 81 as the second image by the meter display 41 and then displaying the autonomously-decelerating image 82 as the second image or the third image by the meter display 41 when a predetermined condition becomes satisfied.

Further, in the present embodiment, the autonomous deceleration control of the second control or the deceleration assistance control is a control of autonomously decelerating the own vehicle 100 when a predetermined condition becomes satisfied.

Below, the first control (or the sign assistance control) and the second control (or the deceleration assistance control) will be described in detail.

When the vehicle driving assistance apparatus 10 detects the deceleration assistance target sign 300 in a situation where the deceleration assistance control is not requested to be executed (that is, the second control is rendered invalid), the vehicle driving assistance apparatus 10 starts to display the continuously-lighting sign image 71 showing the detected deceleration assistance target sign 300 by the meter display 41 as shown in FIG. 3A. The continuously-lighting sign image 71 shown in FIG. 3A is an image which shows the stop sign.

Thereafter, when the accelerator pedal operation (i.e., the operation applied to the accelerator pedal 51) is not released, and the target distance D decreases and reaches a predetermined distance or a first distance D1, the vehicle driving assistance apparatus 10 starts to display the blinking sign image 72 showing the detected deceleration assistance target sign 300 by the meter display 41 as shown in FIG. 3B.

That is, in a situation where the deceleration assistance control (i.e., the second control) is not requested to be executed when the vehicle driving assistance apparatus 10 detects the deceleration assistance target sign 300 (i.e., the traffic information which shows a place where the own vehicle 100 is required to be decelerated), the vehicle driving assistance apparatus 10 starts to display the blinking sign image 72 (i.e., the first image) by the meter display 41 even when a deceleration requirement level does not reach a relatively high level or a first deceleration requirement level. The deceleration requirement level is a level which represents a necessity for the driver of the own vehicle 100 to carry out a deceleration operation.

It should be noted that the deceleration operation carried out by the driver of the own vehicle 100 is, for example, (i) releasing the operation applied to the accelerator pedal 51 or (ii) applying an operation to the brake pedal 53. Further, the blinking sign image 72 shown in FIG. 3B is also an image which shows the stop sign.

Thereafter, when the accelerator pedal operation is released, the vehicle driving assistance apparatus 10 terminates displaying the blinking sign image 72.

On the other hand, when the vehicle driving assistance apparatus 10 detects the deceleration assistance target thing 200, based on the map information, but the vehicle driving assistance apparatus 10 has not detected the traffic sign which shows the detected deceleration assistance target thing 200 (i.e., the deceleration assistance target sign 300) in a situation where (i) the deceleration assistance control is requested to be executed (i.e., the second control is rendered valid), the vehicle driving assistance apparatus 10 starts to display the accelerator pedal release recommendation image 81 by the meter display 41 as shown in FIG. 4A at a point of time when the target distance D decreases and reaches the first distance D1.

Thereafter, when the accelerator pedal operation is released, the vehicle driving assistance apparatus 10 terminates displaying the accelerator pedal release recommendation image 81 and starts to display the autonomously-decelerating image 82 by the meter display 41 as shown in FIG. 4B.

Further, when the vehicle driving assistance apparatus 10 detects the deceleration assistance target thing 200, based on the map information and detects the deceleration assistance target sign 300 which shows the detected deceleration assistance target thing 200 in a situation where (i) the deceleration assistance control is requested to be executed (i.e., the second control is rendered valid), the vehicle driving assistance apparatus 10 displays neither the sign image 70 nor the accelerator pedal release recommendation image 81 by the meter display 41 until the target distance D decreases and reaches the first distance D1.

In other words, in a situation where the deceleration assistance control is requested to be executed when the vehicle driving assistance apparatus 10 detects the deceleration assistance target thing 200 and the deceleration assistance target sign 300 (that is, the traffic information showing the place where the own vehicle 100 is required to be decelerated), the vehicle driving assistance apparatus 10 displays neither the sign image 70 nor the accelerator pedal release recommendation image 81 by the meter display 41.

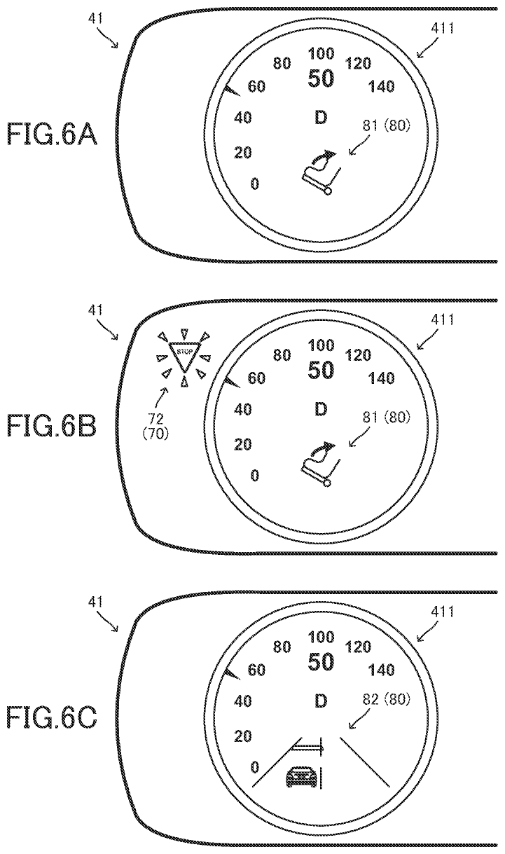

Thereafter, when the target distance D decreases and reaches the first distance D1 without the accelerator pedal operation being released, the vehicle driving assistance apparatus 10 starts to display the accelerator pedal release recommendation image 81 (i.e., the second image) as shown in FIG. 6A. In this case, the vehicle driving assistance apparatus 10 does not display the sign image 70 (i.e., the first image) by the meter display 41.

In other words, when the vehicle driving assistance apparatus 10 detects the deceleration assistance target thing 200 and the deceleration assistance target sign 300 and then the target distance D decreases and reaches the first distance D1 and as a result the deceleration requirement level (i.e., the level representing the necessity for the driver of the own vehicle 100 to carry out the deceleration operation) reaches the first deceleration requirement level, the vehicle driving assistance apparatus 10 does not display both of the accelerator pedal release recommendation image 81 and the sign image 70 by the meter display 41, but starts to display only the accelerator pedal release recommendation image 81 (i.e., the second image) by the meter display 41.

Thereafter, when the target distance D decreases and reaches a predetermined distance or a second distance D2 without the accelerator pedal operation being released, the vehicle driving assistance apparatus 10 starts to display the blinking sign image 72 (i.e., the alerting image or the first image) by the meter display 41, continuing displaying the accelerator pedal release recommendation image 81 (i.e., the second image) as shown in FIG. 6B. It should be noted that the second distance D2 is set to a distance shorter than the first distance D1.

In other words, when the target distance D decreases and reaches the second distance D2 and as a result the deceleration requirement level reaches a second deceleration requirement level higher than the first deceleration requirement level, the vehicle driving assistance apparatus 10 starts to display the blinking sign image 72 (i.e., the first image) by the meter display 41.

Thereafter, when the accelerator pedal operation is released, the vehicle driving assistance apparatus 10 terminates displaying the accelerator pedal release recommendation image 81 (i.e., the second image) and the blinking sign image 72 (i.e., the first image) by the meter display 41, starts to display the autonomously-decelerating image 82 (i.e., the second image or the third image) by the meter display 41 as shown in FIG. 6C, and starts to execute the autonomous deceleration control.

In other words, when the vehicle driving assistance apparatus 10 starts to display the blinking sign image 72 (i.e., the first image) by the meter display 41 in response to the deceleration requirement level reaching the second deceleration requirement level and then the driver releases the acceleration operation, the vehicle driving assistance apparatus 10 starts to execute the autonomous deceleration control.

As can be understood from the above description, the vehicle driving assistance apparatus 10 starts to display the first image at an earlier point of time in the situation where the second control (i.e., the deceleration assistance control) is rendered invalid, compared with in the situation where when the second control is rendered valid.

Thereby, the first image starts to be displayed at the earlier point of time in the situation where the second control (i.e., the deceleration assistance control) is rendered invalid, compared with in the situation where when the second control is rendered valid. Thus, the traffic information can be informed the driver well in advance.

Further, as can be understood from the above description, the vehicle driving assistance apparatus 10 is configured to execute the first control or the second control, based on the target distance D (i.e., the distance between the own vehicle 100 and the first area shown by the detected traffic information) after the vehicle driving assistance apparatus 10 detects the traffic information. In addition, the vehicle driving assistance apparatus 10 is configured to start to display the first image at a point of time when the target distance D is longer in the situation where the second control is rendered invalid, compared with in the situation where the second control is rendered valid.

Further, the vehicle driving assistance apparatus 10 may be configured to (i) calculate and acquire a predicted reaching period of time TTC as a parameter representing the target distance D and (ii) use the predicted reaching period of time TTC in place of the target distance D. In this case, the predicted reaching period of time TTC is a value acquired by dividing the target distance D by the own vehicle moving speed V (TTC=D/V).

In this case, the vehicle driving assistance apparatus 10 is configured to start to display the continuously-lighting sign image 71 (i.e., the first image) by the meter display 41 in response to detecting the deceleration assistance target sign 300 in the situation where the deceleration assistance control is not requested to be executed (i.e., the second control is rendered invalid) and thereafter, (ii) start to display the blinking sign image 72 (i.e., the first image) by the meter display 41 when the predicted reaching period of time TTC decreases and reaches a predetermined period of time or a first period of time TTC1 without the accelerator pedal operation being released. It should be noted that in this case, the vehicle driving assistance apparatus 10 terminates displaying the blinking sign image 72 (i.e., the first image) when the accelerator pedal operation is released.

On the other hand, when the vehicle driving assistance apparatus 10 detects the deceleration assistance target thing 200, based on the map information, but the vehicle driving assistance apparatus 10 has not detected the deceleration assistance target sign 300 which shows the detected deceleration assistance target thing 200 in the situation where the deceleration assistance control is requested to be executed (i.e., the second control is rendered valid), the vehicle driving assistance apparatus 10 starts to display the accelerator pedal release recommendation image 81 (i.e., the second image) by the meter display 41 at a point of time when the predicted reaching period of time TTC decreases and reaches the first period of time TTC1. It should be noted that in this case, when the accelerator pedal operation is released, the vehicle driving assistance apparatus 10 terminates displaying the accelerator pedal release recommendation image 81 (i.e., the second image) and starts to display the autonomously-decelerating image 82 (i.e., the second image) by the meter display 41.

In addition, the vehicle driving assistance apparatus 10 is configured to display neither the sign image 70 (i.e., the first image) nor the accelerator pedal release recommendation image 81 (i.e., the second image) by the meter display 41 until the predicted reaching period of time TTC decreases and reaches the first period of time TTC1 when the vehicle driving assistance apparatus 10 detects the deceleration assistance target thing 200, based on the map information and detects the deceleration assistance target sign 300 which shows the detected deceleration assistance target thing 200 in the situation where the deceleration assistance control is requested to be executed (i.e., the second control is rendered valid).

Thereafter, when the predicted reaching period of time TTC decreases and reaches the first period of time TTC1 without the accelerator pedal operation being released, the vehicle driving assistance apparatus 10 starts to display the accelerator pedal release recommendation image 81 (i.e., the second image). In this case, the vehicle driving assistance apparatus 10 is configured to not display the sign image 70 (i.e., the first image) by the meter display 41.

Thereafter, when the predicted reaching period of time TTC decreases and reaches a predetermined period of time or a second period of time TTC2 without the accelerator pedal operation being released, the vehicle driving assistance apparatus 10 starts to display the blinking sign image 72 (i.e., the alerting image or the first image) by the meter display 41, continuing displaying the accelerator pedal release recommendation image 81 (i.e., the second image). It should be noted that the second period of time TTC2 is set to a value shorter than the first period of time TTC1.

Thereafter, when the accelerator pedal operation is released, the vehicle driving assistance apparatus 10 terminates displaying the accelerator pedal release recommendation image 81 (i.e., the second image) and the blinking sign image 72 (i.e., the first image) by the meter display 41, starts to display the autonomously-decelerating image 82 (i.e., the second image or the third image) by the meter display 41, and starts to execute the autonomous deceleration control.

Further, the vehicle driving assistance apparatus 10 may be configured to (i) display the sign image 70 (i.e., the first image) or the blinking sign image 72 (i.e., the alerting image or the first image) by the meter display 41 at any point of time until the target distance D decreases and reaches the second distance D2 unless the accelerator pedal operation is not released when the vehicle driving assistance apparatus 10 detects the deceleration assistance target thing 200, based on the map information and the deceleration assistance target sign 300 showing the detected deceleration assistance target thing 200 in the situation where the deceleration assistance control is requested to be executed (i.e., the second control is rendered valid), and (ii) starts to execute the autonomous deceleration control when the accelerator pedal operation is released. In this case, the vehicle driving assistance apparatus 10 does not display the accelerator pedal release recommendation image 81 (i.e., the second image). Further, in this case, the vehicle driving assistance apparatus 10 may be configured to display the autonomously-decelerating image 82 (i.e., the second image or the third image) while the vehicle driving assistance apparatus 10 executes the autonomous deceleration control. Alternatively, the vehicle driving assistance apparatus 10 may be configured to not display the autonomously-decelerating image 82 (i.e., the second image or the third image) while the vehicle driving assistance apparatus 10 executes the autonomous deceleration control.

Further, when the deceleration assistance target thing 200 and the deceleration assistance target sign 300 (i.e., the traffic information showing the place where the own vehicle 100 is required to be decelerated) are both detected in the situation where the deceleration assistance control (i.e., the second control) is requested to be executed, if at least one of the deceleration assistance target thing 200 and the deceleration assistance target sign 300 is displayed, the driver of the own vehicle 100 may mistakenly understand that the own vehicle 100 is soon decelerated by the autonomous deceleration control of the deceleration assistance control without carrying out the deceleration operation and thus does not carry out the deceleration operation and as a result, the driver may start decelerating the own vehicle 100 late.

With the vehicle driving assistance apparatus 10, even when the deceleration assistance target sign 300 and the deceleration assistance target thing 200 (i.e., the traffic information showing the place where the own vehicle 100 is required to be decelerated) are detected in the situation where the deceleration assistance control (i.e., the second control) is requested to be executed, neither the sign image 70 (i.e., the first image) nor the deceleration assistance image 80 (i.e., the second image) are displayed. Then, any of the sign image 70 (i.e., the first image) and the deceleration assistance image 80 (i.e., the second image), in the present embodiment, the deceleration assistance image 80 (in particular, the accelerator pedal release recommendation image 81) is displayed at a point of time when the target distance D decreases and reaches the first distance D1 (i.e., the deceleration requirement level becomes relatively high) after the deceleration assistance target sign 300 and the deceleration assistance target thing 200 are detected. Thus, it can be prevented from carrying out the deceleration operation by the operator of the vehicle late.

It should be noted that the present invention is not limited to the aforementioned embodiments, and various modifications can be employed within the scope of the present invention.

For example, the vehicle driving assistance apparatus 10 may be configured to set the first distance D1 and the second distance D2, depending on a realization-probability index value IDX, i.e., an index value which represents a level of easiness that the driver sees and realizes the deceleration assistance target sign 300 and the deceleration assistance target thing 200, in other words, an index value which represents a level of probability that the driver realizes existence of the place where the own vehicle 100 is required to be decelerated.

In this regard, the driver can realize the deceleration assistance target sign 300 and the deceleration assistance target thing 200 more easily when the driver drives the own vehicle 100 in the daytime, compared with when the driver drives the own vehicle 100 in the night-time. As a result, the level of the probability that the driver realizes the deceleration assistance target sign 300 and the deceleration assistance target thing 200, is high when the driver drives the own vehicle 100 in the daytime, compared with when the driver drives the own vehicle 100 in the night-time. Therefore, the level of the probability that the driver realizes the existence of the place where the own vehicle 100 is required to be decelerated, is high when the driver drives the own vehicle 100 in the daytime, compared with when the driver drives the own vehicle 100 in the night-time.

Thus, even when the information providing image and the alerting image are not displayed by the meter display 41 until the own vehicle 100 moves to near the deceleration assistance target thing 200, a level of probability that the driver voluntarily releases the accelerator pedal operation and operates the brake pedal 53 to decelerate the own vehicle 100, is high since the driver realizes the deceleration assistance target sign 300 and the deceleration assistance target thing 200.

Accordingly, the vehicle driving assistance apparatus 10 may be configured to (i) acquire the realization-probability index value IDX and (ii) set the first distance D1 and the second distance D2 such that the first distance D1 and the second distance D2 set when the acquired realization-probability index value IDX is great, are smaller than the first distance D1 and the second distance D2 set when the acquired realization-probability index value IDX is small, respectively. In this case, the realization-probability index value IDX acquired in the daytime is greater than the realization-probability index value IDX acquired in the night-time.

In particular, the vehicle driving assistance apparatus 10 may be configured to (i) acquire the realization-probability index value IDX which is great when luminance outside the own vehicle 100 is great, compared with when the luminance outside the own vehicle 100 is small, and (ii) set the first distance D1 and the second distance D2 such that the first distance D1 and the second distance D2 set when the acquired realization-probability index value IDX is great, are smaller than the first distance D1 and the second distance D2 set when the acquired realization-probability index value IDX is small.

In particular, the vehicle driving assistance apparatus 10 may be configured to (i) acquire the realization-probability index value IDX increasing as the luminance outside the own vehicle 100 increases and (ii) set the first distance D1 and the second distance D2 such that the first distance D1 and the second distance D2 decreases as the acquired realization-probability index value IDX increases.

In other words, the vehicle driving assistance apparatus 10 may be configured to set the first deceleration requirement level and the second deceleration requirement level to higher levels, respectively when the realization-probability index value IDX (i.e., the index value representing the level of the probability that the driver realizes the existence of the place where the own vehicle 100 is required to be decelerated) is equal to or greater than a predetermined index value, compared with when the realization-probability index value IDX is smaller than the predetermined index value in the situation where the deceleration assistance control (i.e., the second control) is requested to be executed when the vehicle driving assistance apparatus 10 detects the traffic information showing the place where the own vehicle 100 is required to be decelerated.

Further, when the vehicle driving assistance apparatus 10 detects several kinds of the traffic information and displays an image showing at least one of the several kinds of the traffic information as the second image, the vehicle driving assistance apparatus 10 may be configured to display only an image as the first image showing the traffic information other than the traffic information shown by the second image.

In particular, when the vehicle driving assistance apparatus 10 detects several kinds of the traffic information, the vehicle driving assistance apparatus 10 may be configured to (i) select the traffic information showing the deceleration assistance target thing 200 and having the highest priority of being displayed by the meter display 41 (the highest priority of being provided) from the detected traffic information and (ii) display an image showing the selected traffic information as the second image by the meter display 41. In this case, the vehicle driving assistance apparatus 10 may be configured to (i) select the predetermined number of the kinds of the traffic information in descending order according to the priority of being displayed by the meter display 41 (i.e. the priority of being provided) from the remaining kinds of the traffic information and (ii) display images showing the selected kinds of the traffic information as the first image by the meter display 41. In particular, the vehicle driving assistance apparatus 10 may be configured to (i) select the kind of the traffic information having the highest priority of being displayed by the meter display 41 (i.e., the highest priority of being provided) from the remaining kinds of the traffic information and (ii) display an image showing the selected kind of the traffic information as the first image by the meter display 41.

In this case, for example, when (i) the vehicle driving assistance apparatus 10 detects a speed limit, the stop line, and a preceding vehicle (i.e., a vehicle moving in front of the own vehicle 100) as the traffic information, (ii) the traffic information having the highest priority of being displayed by the meter display 41 is the speed limit, and (iii) the traffic information having the second priority of being displayed by the meter display 41 is the stop line, the vehicle driving assistance apparatus 10 displays an image showing information on the speed limit as the second image by the meter display 41 and displays an image showing information on the stop line as the first image by the meter display 41.

It should be noted that in a situation where the speed limit is the deceleration assistance target thing 200, and the vehicle driving assistance apparatus 10 detects the speed limit for the own vehicle 100 as the traffic information, the vehicle driving assistance apparatus 10 is configured to decelerate the own vehicle 100 and decrease the own vehicle moving speed V to the speed limit by the deceleration assistance control when the own vehicle moving speed V is greater than the detected speed limit.

Further, in a situation where the preceding vehicle is the deceleration assistance target thing 200, and the vehicle driving assistance apparatus 10 detects the preceding vehicle as the traffic information, the vehicle driving assistance apparatus 10 is configured to decelerate the own vehicle 100 and increase a distance between the detected preceding vehicle and the own vehicle 100 to a predetermined distance by the deceleration assistance control when the distance between the detected preceding vehicle and the own vehicle 100 becomes shorter than the predetermined distance.

### Specific Operations of Vehicle Driving Assistance Apparatus

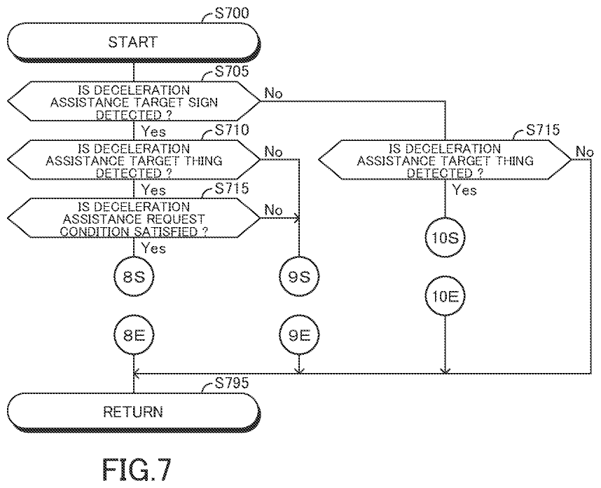

Next, specific operations of the own vehicle 100 will be described. The vehicle driving assistance apparatus 10 is configured to execute a routine shown in FIG. 7 with a predetermined calculation cycle. Therefore, at a predetermined timing, the vehicle driving assistance apparatus 10 starts to execute the routine shown in FIG. 7 from a step S700 and proceeds with the process to a step S705 to determine whether the deceleration assistance target sign 300 is detected.

When the vehicle driving assistance apparatus 10 determines “Yes” at the step S705, the vehicle driving assistance apparatus 10 proceeds with the process to a step S710 to determine whether the deceleration assistance target thing 200 is detected.

When the vehicle driving assistance apparatus 10 determines “Yes” at the step S710, the vehicle driving assistance apparatus 10 proceeds with the process to a step S715 to determine whether a deceleration assistance request condition Cd is satisfied. The deceleration assistance request condition Cd becomes satisfied when the driving assistance operation device 56 is operated in the situation where the vehicle driving assistance apparatus 10 determines that the deceleration assistance control is not requested to be executed. On the other hand, the deceleration assistance request condition Cd becomes unsatisfied when the driving assistance operation device 56 is operated in the situation where the vehicle driving assistance apparatus 10 determines that the deceleration assistance control is requested to be executed.

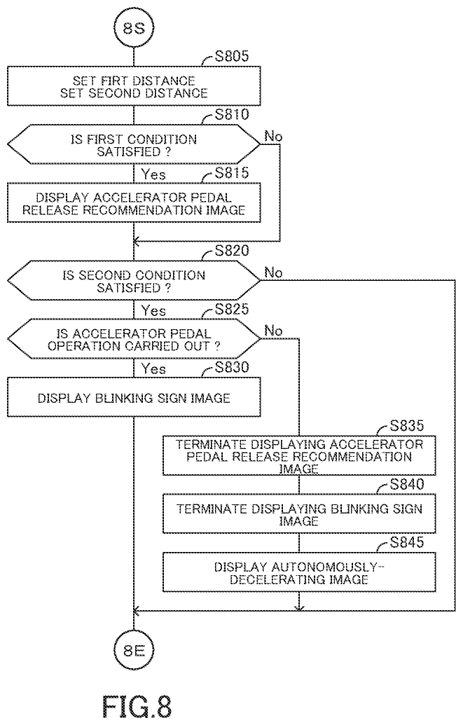

When the vehicle driving assistance apparatus 10 determines “Yes” at the step S715, the vehicle driving assistance apparatus 10 proceeds with the process to a step S805 of a routine shown in FIG. 8 to set the first distance D1 and the second distance D2, depending on the realization-probability index value IDX as described above.

Next, the vehicle driving assistance apparatus 10 proceeds with the process to a step S810 to determine whether a first condition C1 is satisfied. The first condition C1 is satisfied when the target distance D is equal to or smaller than the first distance D1 and greater than the second distance D2.

When the vehicle driving assistance apparatus 10 determines “Yes” at the step S810, the vehicle driving assistance apparatus 10 proceeds with the process to a step S815 to display the accelerator pedal release recommendation image 81. Next, the vehicle driving assistance apparatus 10 proceeds with the process to a step S820.

On the other hand, when the vehicle driving assistance apparatus 10 determines “No” at the step S810, the vehicle driving assistance apparatus 10 proceeds with the process directly to the step S820.

When the vehicle driving assistance apparatus 10 proceeds with the process to the step S820, the vehicle driving assistance apparatus 10 determines whether a second condition C2 is satisfied. The second condition C2 is satisfied when the target distance D is equal to or smaller than the second distance D2.

When the vehicle driving assistance apparatus 10 determines “Yes” at the step S820, the vehicle driving assistance apparatus 10 proceeds with the process to a step S825 to determine whether the accelerator pedal operation is carried out. It should be noted that the vehicle driving assistance apparatus 10 determines that the accelerator pedal operation is carried out when the accelerator pedal operation amount AP is greater than zero (or a predetermined small value greater than zero).

When the vehicle driving assistance apparatus 10 determines “Yes” at the step S825, the vehicle driving assistance apparatus 10 proceeds with the process to a step S830 to display the blinking sign image 72. Next, the vehicle driving assistance apparatus 10 proceeds with the process to a step S795 of the routine shown in FIG. 7 to terminate executing this routine once.

On the other hand, when the vehicle driving assistance apparatus 10 determines “No” at the step S825, the vehicle driving assistance apparatus 10 proceeds with the process to a step S835 to terminate displaying the accelerator pedal release recommendation image 81. Next, the vehicle driving assistance apparatus 10 proceeds with the process to a step S840 to terminate displaying the blinking sign image 72. Next, the vehicle driving assistance apparatus 10 proceeds with the process to a step S845 to display the autonomously-decelerating image 82. Next, the vehicle driving assistance apparatus 10 proceeds with the process to the step S795 of the routine shown in FIG. 7 to terminate executing this routine once.

Further, when the vehicle driving assistance apparatus 10 determines “No” at the step S820, the vehicle driving assistance apparatus 10 proceeds with the process directly to the step S795 of the routine shown in FIG. 7 to terminate executing this routine once.

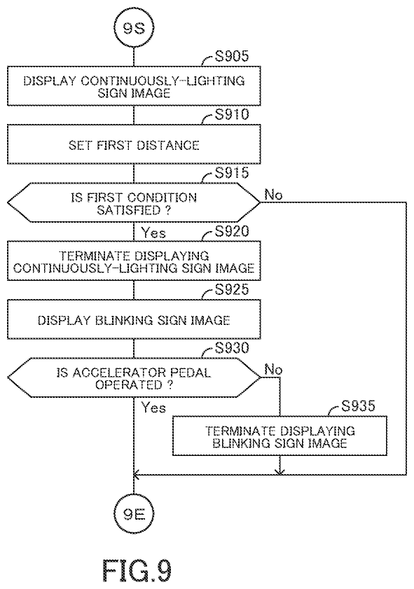

Further, when the vehicle driving assistance apparatus 10 determines “No” at the step S710 or the step S715 of the routine shown in FIG. 7, the vehicle driving assistance apparatus 10 proceeds with the process to a step S905 of a routine shown in FIG. 9 to display the continuously-lighting sign image 71. Next, the vehicle driving assistance apparatus 10 proceeds with the process to a step S910 to set the first distance D1, depending on the realization-probability index value IDX as described above. Next, the vehicle driving assistance apparatus 10 proceeds with the process to a step S915 to determine whether the first condition is satisfied.

When the vehicle driving assistance apparatus 10 determines “No” at the step S915, the vehicle driving assistance apparatus 10 proceeds with the process to a step S920 to terminate displaying the continuously-lighting sign image 71. Next, the vehicle driving assistance apparatus 10 proceeds with the process to a step S925 to display the blinking sign image 72. Next, the vehicle driving assistance apparatus 10 proceeds with the process to a step S930 to determine whether the accelerator pedal operation is carried out.

When the vehicle driving assistance apparatus 10 determines “Yes” at the step S930, the vehicle driving assistance apparatus 10 proceeds with the process directly to the step S795 of the routine shown in FIG. 7 to terminate executing this routine once.

On the other hand, when the vehicle driving assistance apparatus 10 determines “No” at the step S930, the vehicle driving assistance apparatus 10 proceeds with the process to a step S935 to terminate displaying the blinking sign image 72. Next, the vehicle driving assistance apparatus 10 proceeds with the process to the step S795 of the routine shown in FIG. 7 to terminate executing this routine once.

Further, when the vehicle driving assistance apparatus 10 determines “No” at the step S915, the vehicle driving assistance apparatus 10 proceeds with the process directly to the step S795 of the routine shown in FIG. 7 to terminate executing this routine once.

Further, when the vehicle driving assistance apparatus 10 determines “No” at the step S705 of the routine shown in FIG. 7, the vehicle driving assistance apparatus 10 proceeds with the process to a step S715 to determine whether the deceleration assistance target thing 200 is detected.

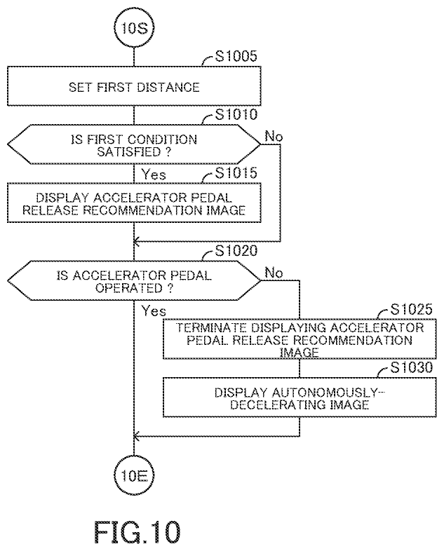

When the vehicle driving assistance apparatus 10 determines “Yes” at the step S715, the vehicle driving assistance apparatus 10 proceeds with the process to a step S1005 of a routine shown in FIG. 10 to set the first distance D1, depending on the realization-probability index value IDX as described above. Next, the vehicle driving assistance apparatus 10 proceeds with the process to a step S1010 to determine whether the first condition C1 is satisfied.

When the vehicle driving assistance apparatus 10 determines “Yes” at the step S1010, the vehicle driving assistance apparatus 10 proceeds with the process to a step S1015 to display the accelerator pedal release recommendation image 81. Next, the vehicle driving assistance apparatus 10 proceeds with the process to a step S1020.

On the other hand, when the vehicle driving assistance apparatus 10 determines “No” at the step S1010, the vehicle driving assistance apparatus 10 proceeds with the process directly to the step S1020.

When the vehicle driving assistance apparatus 10 proceeds with the process to the step S1020, the vehicle driving assistance apparatus 10 determines whether the accelerator pedal operation is carried out.

When the vehicle driving assistance apparatus 10 determines “Yes” at the step S1020, the vehicle driving assistance apparatus 10 proceeds with the process directly to the step S795 of the routine shown in FIG. 7 to terminate executing this routine once.

On the other hand, when the vehicle driving assistance apparatus 10 determines “No” at the step S1020, the vehicle driving assistance apparatus 10 proceeds with the process to a step S1025 to terminate displaying the accelerator pedal release recommendation image 81. Next, the vehicle driving assistance apparatus 10 proceeds with the process to a step S1030 to display the autonomously-decelerating image 82. Next, the vehicle driving assistance apparatus 10 proceeds with the process to the step S795 of the routine shown in FIG. 7 to terminate executing this routine once.

Further, when the vehicle driving assistance apparatus 10 determines “No” at the step S715 of the routine shown in FIG. 7, the vehicle driving assistance apparatus 10 proceeds with the process directly to the step S795 to terminate executing this routine once.

The specific operations of the vehicle driving assistance apparatus 10 have been described.

What is claimed is:

1. A vehicle driving assistance apparatus, comprising an electronic control unit configured to execute:
a first control to display a first image by a displaying device,
the first image being an image which displays traffic information on a place where a vehicle will move; and
a second control including an autonomous deceleration control to autonomously decelerate the vehicle in response to the traffic information,
wherein the electronic control unit is configured to:
render the second control valid or invalid;
start to display the first image at a predetermined valid-state point of time in a situation where the second control is rendered valid; and
start to display the first image at a predetermined invalid-state point of time in a situation where the second control is rendered invalid, and
wherein the predetermined invalid-state point of time is earlier than the predetermined valid-state point of time.

2. The vehicle driving assistance apparatus as claimed in claim 1,
wherein the vehicle driving assistance apparatus comprises a detection section which detects the traffic information on the place where the vehicle will move,
wherein the electronic control unit is configured to execute one of the first control and the second control, based on a first area distance between the vehicle and a first area shown by the traffic information after the electronic control unit detects the traffic information,
wherein the electronic control unit is configured to:
start to display the first image at a point of time when the first area distance reaches a predetermined valid-state distance; and
start to display the first image at a point of time when the first area distance reaches a predetermined invalid-state distance, and
wherein the predetermined invalid-state distance is longer than the predetermined valid-state distance.

3. The vehicle driving assistance apparatus as claimed in claim 2,
wherein the electronic control unit is configured to:
acquire a predicted reaching period of time as a parameter which represents the first area distance,
the predicted reaching period of time being a period of time predicted for the vehicle to take to reach the first area;
start to display the first image at a point of time when the predicted reaching period of time reaches a predetermined valid-state period of time in the situation where the second control is rendered valid; and
start to display the first image at a point of time when the predicted reaching period of time reaches a predetermined invalid-state period of time in the situation where the second control is rendered invalid, and
wherein the predetermined invalid-state period of time is longer than the predetermined valid-state period of time.

4. The vehicle driving assistance apparatus as claimed in claim 3, wherein the electronic control unit is configured to execute the second control to execute the autonomous deceleration control after the electronic control unit starts to display one of the first image and a second image relating to the second control.

5. The vehicle driving assistance apparatus as claimed in claim 4, wherein the electronic control unit is configured to display the first image after the electronic control unit starts displaying the second image in the situation where the second control is rendered valid.

6. The vehicle driving assistance apparatus as claimed in claim 5,
wherein the electronic control unit is configured to:
start to display the first image when an operator of the vehicle does not release an acceleration operation after the electronic control unit starts displaying the second image in the situation where the second control is rendered valid; and
start to execute the autonomous deceleration control when the operator of the vehicle releases the acceleration operation after the electronic control unit starts displaying the first image in the situation where the second control rendered valid.

7. The vehicle driving assistance apparatus as claimed in claim 6, wherein the electronic control unit is configured to display an image of recommending that the operator releases the acceleration operation as the second image.

8. The vehicle driving assistance apparatus as claimed in claim 6, wherein the electronic control unit is configured to execute the second control to (i) display a third image relating the second control, (ii) execute the autonomous deceleration control, and (iii) not display the first image when the operator of the vehicle has released the acceleration operation.

9. The vehicle driving assistance apparatus as claimed in claim 1,
wherein the electronic control unit is configured to:
start to display the first image at a predetermined small-index-value point of time when the electronic control unit detects the traffic information, and a realization index value is smaller than a predetermined index value in a situation where the second control is requested to be executed; and
start to display the first image at a predetermined great-index-value point of time when the electronic control unit detects the traffic information, and the realization index value is equal to or greater than the predetermined index value in a situation where the second control is requested to be executed,
wherein the realization index value is an index value which represents a probability that the operator of the vehicle has realized a place where the vehicle is required to be decelerated, and
wherein the predetermined great-index-value point of time is later than the predetermined small-index-value point of time.

10. The vehicle driving assistance apparatus as claimed in claim 4, wherein when the electronic control unit detects the traffic information including first traffic information and second traffic information different from the first traffic information and displays the second image which shows the second traffic information, the electronic control unit is configured to display the first image showing the first traffic information.

11. A vehicle driving assistance method for executing:
a first control to display a first image by a displaying device,
the first image being an image which displays traffic information on a place where a vehicle will move; and
a second control including an autonomous deceleration control to autonomously decelerate the vehicle in response to the traffic information,
wherein the vehicle driving assistance method comprises steps of:
starting to display the first image at a predetermined valid-state point of time in a situation where the second control is rendered valid; and
starting to display the first image at a predetermined invalid-state point of time earlier than the predetermined valid-state point of time in a situation where the second control is rendered invalid.

12. A computer-readable storage medium storing a vehicle driving assistance program which executes:
a first control to display a first image by a displaying device,
the first image being an image which displays traffic information on a place where a vehicle will move; and
a second control including an autonomous deceleration control to autonomously decelerate the vehicle in response to the traffic information,
wherein the vehicle driving assistance program is configured to:
start to display the first image at a predetermined valid-state point of time earlier than the predetermined valid-state point of time in a situation where the second control is rendered valid.
